(19) United States
(12) Patent Application Publication
(10) Pub. No.: US 2014/0309803 A1
(43) Pub. Date: Oct. 16, 2014

(54) SYSTEM FOR ESTIMATING ROAD SLOPE

(71) Applicant: HYUNDAI MOTOR COMPANY, Seoul (KR)

(72) Inventors: Seung Han YOU, Seoul (KR); Young Ho SHIN, Seoul (KR)

(73) Assignee: HYUNDAI MOTOR COMPANY, Seoul (KR)

(21) Appl. No.: 14/012,716

(22) Filed: Aug. 28, 2013

(30) Foreign Application Priority Data
Apr. 15, 2013 (KR) 10-2013-0040864

(51) Int. Cl. G01C 9/02

(52) U.S. Cl. CPC G01C 9/02
USPC 701/1

(57) ABSTRACT

A system for estimating a road slope, includes a signal processor receiving a raw signal including information on acceleration and rotation velocity transmitted from a 6 degrees of freedom (6DOF) inertial sensor, a vehicle motion estimator calculating overall angles of a vehicle based on the signals from the 6DOF inertial sensor filtered by the signal processor and on vehicle measurement information transmitted from a vehicle sensor. The system further includes a vehicle suspension angle estimator calculating a vehicle suspension angle based on the signal from the 6DOF inertial sensor and the vehicle measurement information and a road slope estimator determining a difference between the overall angles of the vehicle and the vehicle suspension angle so as to calculate a road slope.

### CROSS-REFERENCE TO RELATED APPLICATION

This application claims priority to and the benefit of Korean Patent Application No. 10-2013-0040864, filed on Apr. 15, 2013 in the Korean Intellectual Property Office, the disclosure of which by reference is incorporated herein in its entirety.

### TECHNICAL FIELD

The present disclosure relates to a system for estimating a road slope.

### BACKGROUND

In general, vehicle stability control devices estimate a road slope based on lateral acceleration and yaw rate utilizing a 2 degrees of freedom (DOF) inertial sensor or based on longitudinal acceleration, lateral acceleration, and a yaw rate utilizing a 3 DOF inertial sensor.

In those cases, a lateral slope angle on a road is validly calculated only in limited conditions such as when a vehicle corners in an ordinary condition. However, when the vehicle corners with a sharp change in the lateral slope angle, it is difficult to accurately estimate the lateral slope angle.

Further, the above approach is largely influenced by changes in vehicle parameters, such as mass, tire, and a road friction coefficient, because it depends on the physical model of a vehicle.

### SUMMARY

Accordingly, the present disclosure has been made to solve the above-mentioned problems occurring in the prior art while advantages achieved by the prior art are maintained intact.

The present disclosure provides a system for estimating an angle of the road slope in real-time by utilizing a 6DOF inertial sensor.

An aspect of the present disclosure is a system for estimating a road slope, including a signal processor receiving a raw signal including information on acceleration and rotation velocity transmitted from a 6 degrees of freedom (6DOF) inertial sensor, and performing filtering thereon. A vehicle motion estimator calculates overall angles of a vehicle based on the signals from the 6DOF inertial sensor filtered by the signal processor and on vehicle measurement information transmitted from a vehicle sensor. A vehicle suspension angle estimator calculates a vehicle suspension angle based on the signal from the 6DOF inertial sensor and the vehicle measurement information. A road slope estimator determines a difference between the overall angles of the vehicle and the vehicle suspension angle thereby calculating a road slope.

The vehicle sensor may include a steering angle sensor and wheel speed sensors. The vehicle measurement information may include steering angle measurement information and vehicle speed measurement information.

The signal processor may include an offset compensator offset-compensating for the rotation velocity and the acceleration of the vehicle. A non-alignment error compensator compensates for an error of the 6DOF inertial sensor itself.

The offset compensator may perform the rotation velocity correction of the vehicle using Equation 1, and perform the acceleration correction of the vehicle using Equation 2,

$${[ \begin{matrix}{ω}_{x} \\ {ω}_{y} \\ {ω}_{z}\end{matrix} ]}_{offset \text{-} free} = {[ \begin{matrix}{ω}_{x} \\ {ω}_{y} \\ {ω}_{z}\end{matrix} ]}_{raw} - [ \begin{matrix}{ω}_{x , offset} \\ {ω}_{y , offset} \\ {ω}_{z , offset}\end{matrix} ] \qquad [ Equation 1 ]$$

wherein ωₓ, ω_{y}, and ω_{z} denote roll rate, pitch rate and yaw rate, respectively,

$${[ \begin{matrix}{a}_{x} \\ {a}_{y} \\ {a}_{z}\end{matrix} ]}_{offset \text{-} free} = {[ \begin{matrix}{a}_{x} \\ {a}_{y} \\ {a}_{z}\end{matrix} ]}_{raw} - [ \begin{matrix}{a}_{x , offset} \\ {a}_{y , offset} \\ {a}_{z , offset}\end{matrix} ] \qquad [ Equation 2 ]$$

wherein αₓ, α_{y}, and α_{z} denote longitudinal acceleration, lateral acceleration and vertical acceleration, respectively.

The non-alignment error compensator may compensate for an orthogonal error at the time of manufacturing the 6DOF inertial sensor, a sensitivity error of the 6DOF inertial sensor itself, and cross axis sensitivity.

The vehicle motion estimator may include: a static roll/pitch calculator calculating static roll angle and pitch angle of the vehicle using a predetermined acceleration equation, and an initial roll/pitch calculator determining initial roll angle and pitch angle of the vehicle when the vehicle is static (in a standstill state). A roll/pitch gain calculator calculating weighted gain values of the roll angle and pitch angle based on the vehicle measurement information. An overall vehicle roll/pitch estimator calculates overall roll angle and pitch angle of the vehicle based on the information calculated by the static roll/pitch calculator, the initial roll/pitch calculator, and the roll/pitch gain calculator.

The roll/pitch gain calculator may assign weight to the static roll angle and pitch angle by comparing a signal from the 6 DOF inertial sensor and the vehicle measurement information with a lookup table for pitch angles and a lookup table for roll angles.

The roll/pitch gain calculator may include a pitch-angle-weight determiner determining a dynamic condition if the levels of signals of longitudinal acceleration, pitch rate, lateral slip angle of a rear wheel, and yaw rate are equal to or higher than reference levels. The static pitch angle gain value is adjusted to a smaller value based on the lookup table for pitch angles. A roll-angle-weight determiner determines a dynamic condition if the levels of the signal of the change rate of the steering angle, lateral acceleration, pseudo vehicle roll, and a lateral slip angle signal of a rear wheel are equal to or higher than reference levels. The static roll angle gain value to a smaller value based on the lookup table for roll angles.

The pitch-angle-weight determiner may adjust the static pitch angle gain value to a relatively small value, as the value increases, which is calculated by applying signals of longitudinal acceleration, pitch rate, a lateral slip angle of a rear wheel, and yaw rate to a predetermined gyro integration equation.

The roll-angle-weight determiner may adjust the static roll angle gain value to a relatively small value as the value increases, which is calculated by applying signals of the change rate of the steering angle, lateral velocity, pseudo vehicle roll, and a lateral slip angle of a rear wheel to a predetermined gyro integration equation.

Various features and advantages of the present disclosure will become more recognized from the following description with reference to the accompanying drawings.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a block diagram illustrating the configuration of a system for estimating a road slope according to an embodiment of the present disclosure;

FIG. 2 is a block diagram illustrating the configuration of a signal processor of FIG. 1 in detail;

FIG. 3 is a block diagram illustrating the configuration of a vehicle motion estimator of FIG. 1 in detail; and

FIG. 4 is a block diagram illustrating the configuration of a roll/pitch gain calculator of FIG. 3 in detail.

### DETAILED DESCRIPTION

The above and other objects, features and advantages of the present disclosure will be more clearly understood from the following detailed description taken in conjunction with the accompanying drawings. It is to be noted that same elements appearing on different drawings will have same reference number. Further, in describing the present disclosure, descriptions of well-known features may be omitted in order not to obscure the gist of the present disclosure. Hereinafter, embodiments of the present disclosure will be described in detail with reference to the accompanying drawings.

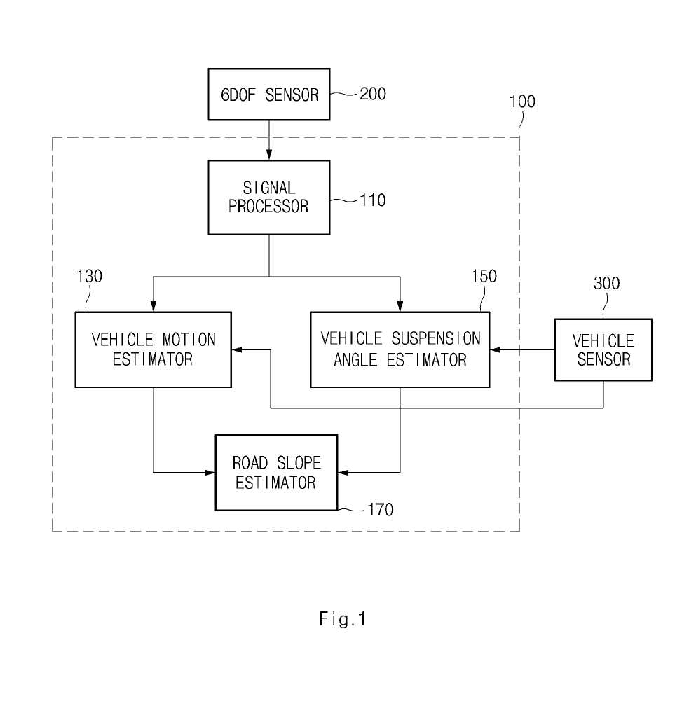

Referring to FIG. 1, a system for estimating a road slope 100 may include a signal processor 110, a vehicle motion estimator 130, a vehicle suspension angle estimator 150, and a road slope estimator 170.

Specifically, the signal processor 110 may receive a raw signal including information on acceleration and rotation velocity transmitted from a 6 degrees of freedom (6DOF) inertial sensor 200 so as to perform filtering.

The 6DOF inertial sensor 200 refers to a sensor which is capable of measuring both translational and rotational motions about three axes.

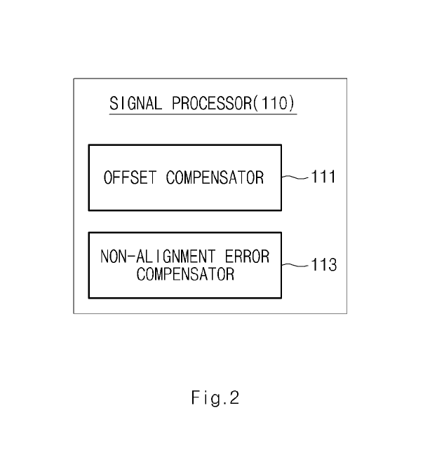

As shown in FIG. 2, the signal processor 110 may include an offset compensator 111 to compensate for rotation velocity and acceleration of a vehicle, and a non-alignment error compensator 113 to compensate for an error caused by the 6DOF inertial sensor 200 itself.

The offset compensator 111 performs a gyro sensor offset compensation and an acceleration sensor offset compensation. The gyro sensor offset compensation defines an offset as an average value for a certain time of period when the vehicle is static (in a standstill state), and rate (angular velocity) is under a certain value. The acceleration sensor offset compensation is to define an offset as an average value for a certain time of period when the vehicle is static (in a standstill state), and acceleration is under a certain value.

Specifically, the offset compensator 111 may perform a rotation velocity correction of a vehicle using Equation 1 and may perform an acceleration correction of the vehicle using Equation 2.

$${[ \begin{matrix}{ω}_{x} \\ {ω}_{y} \\ {ω}_{z}\end{matrix} ]}_{offset \text{-} free} = {[ \begin{matrix}{ω}_{x} \\ {ω}_{y} \\ {ω}_{z}\end{matrix} ]}_{raw} - [ \begin{matrix}{ω}_{x , offset} \\ {ω}_{y , offset} \\ {ω}_{z , offset}\end{matrix} ] \qquad [ Equation 1 ]$$

ωₓ, ω_{y}, and ω_{z} denote roll rate, pitch rate and yaw rate, respectively.

$${[ \begin{matrix}{a}_{x} \\ {a}_{y} \\ {a}_{z}\end{matrix} ]}_{offset \text{-} free} = {[ \begin{matrix}{a}_{x} \\ {a}_{y} \\ {a}_{z}\end{matrix} ]}_{raw} - [ \begin{matrix}{a}_{x , offset} \\ {a}_{y , offset} \\ {a}_{z , offset}\end{matrix} ] \qquad [ Equation 2 ]$$

αₓ, α_{y}, and α_{z} denote longitudinal acceleration, lateral acceleration and vertical acceleration, respectively.

The non-alignment error compensator 113 may compensate for an orthogonal error at the time of manufacturing the 6DOF inertial sensor 200, a sensitivity error of the 6DOF inertial sensor itself, and a cross axis sensitivity.

Here, the non-alignment error compensator 113 may compensate for a signal from 6DOF inertial sensor 200 from which the offset has been removed by the offset compensator 111.

The above-described non-alignment error compensator 113 may compensate for an error of the 6DOF inertial sensor 200 itself using Equations 3 and 4, such that the reliability of the values measured by the sensors may be further increased.

$${[ \begin{matrix}{ω}_{x} \\ {ω}_{y} \\ {ω}_{z}\end{matrix} ]}_{final} = {{K}_{3 \times 3}^{o} [ \begin{matrix}{ω}_{x} \\ {ω}_{y} \\ {ω}_{z}\end{matrix} ]}_{offset \text{-} free} \qquad [ Equation 3 ]$$

ωₓ, ω_{y}, and ω_{z} denote roll rate, pitch rate and yaw rate, respectively.

$${[ \begin{matrix}{a}_{x} \\ {a}_{y} \\ {a}_{z}\end{matrix} ]}_{final} = {{K}_{3 \times 3}^{a} [ \begin{matrix}{a}_{x} \\ {a}_{y} \\ {a}_{z}\end{matrix} ]}_{offset \text{-} free} \qquad [ Equation 4 ]$$

αₓ, α_{y}, and α_{z} denote longitudinal acceleration, lateral acceleration and vertical acceleration, respectively.

The vehicle motion estimator 130 may calculate overall angles of a vehicle based on the signal from the 6DOF inertial sensor filtered by the signal processor 110 and vehicle measurement information transmitted from a vehicle sensor 300.

The vehicle sensor 300 may include a steering angle sensor and wheel speed sensors, and thus the vehicle measurement information may include steering angle measurement information and vehicle speed measurement information.

The steering angle sensor (SAS) serves to determine the steering direction, angle, and velocity and deliver them to a vehicle dynamic control (VDC) and electronic control unit (ECU). The wheel speed sensors, each mounted on the respective one of four wheels, serve to sense the rotation speed of the wheels based on changes in magnetic field lines in a tone wheel and sensors. Sensed information is input into a computer, thereby controlling the pressure of the hydraulic brake at the time of quick braking or braking on a slippery road, so as to keep a vehicle under control and shorten a braking distance.

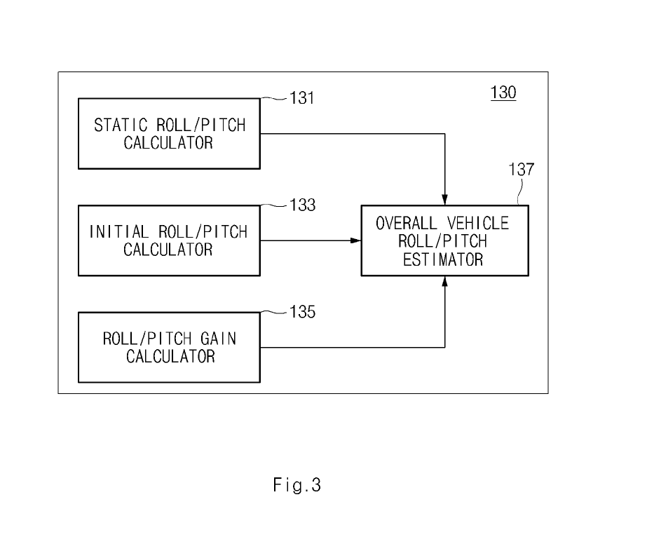

Referring to FIG. 3, the vehicle motion estimator 130 may include a static roll/pitch calculator 131, an initial roll/pitch calculator 133, a roll/pitch gain calculator 135, and an overall vehicle roll/pitch estimator 137.

Specifically, the static roll/pitch calculator 131 may calculate static roll angle and pitch angle using a predetermined acceleration equation.

More specifically, the static roll/pitch calculator 131 may calculate the static roll angle and pitch angle using Equation 5 based on an acceleration sensor.

$$[ \begin{matrix}{\dot{v}}_{x} \\ {\dot{v}}_{y} \\ {\dot{v}}_{z}\end{matrix} ] = [ \begin{matrix}0 & {ω}_{z} & - {ω}_{y} \\ - {ω}_{z} & 0 & {ω}_{x} \\ {ω}_{y} & - {ω}_{x} & 0\end{matrix} ] [ \begin{matrix}{v}_{x} \\ {v}_{y} \\ {v}_{z}\end{matrix} ] + [ \begin{matrix}{a}_{x} \\ {a}_{y} \\ {a}_{z}\end{matrix} ] - g [ \begin{matrix}- sin \hat{θ} \\ sin \hat{φ} cos \hat{θ} \\ cos \hat{φ} cos \hat{θ}\end{matrix} ] \\ \hat{θ} = {sin}^{- 1} ( \frac{- {a}_{x} - {ω}_{x} {v}_{y} + {\hat{v}}_{x}}{g} ) \\ \hat{φ} = {sin}^{- 1} ( \frac{{a}_{x} - {ω}_{x} {v}_{x} - {\dot{v}}_{x}}{g} ) \qquad [ Equation 5 ]$$

ωₓ, ω_{y} and ω_{z} denote roll rate, pitch rate and yaw rate, respectively, and αₓ, α_{y}, and α_{z} denote longitudinal acceleration, lateral acceleration and vertical acceleration, respectively.

The initial roll/pitch calculator 133 may determine initial roll angle and pitch angle when the vehicle is static. For example, the initial roll/pitch calculator 133 determines initial roll angle and pitch angle before a vehicle begins to travel.

The roll/pitch gain calculator 135 may calculate a weighted gain value of a roll angle and a pitch angle based on the vehicle measurement information. Here, the weighted gain value refers a value used to determine the portions of the static roll angle and the pitch angle to be reflected in a given physical quantity. That is, the higher the weighted gain value is, the more the static roll angle and pitch angle are reflected in determining the overall roll angle and pitch angle. If the weighted gain value becomes smaller, the static roll angle and pitch angle are less reflected in determining the overall roll angle and pitch angle, and the portion of a gyro integration equation is relatively increased.

Here, the roll/pitch gain calculator 135 may assign weight to the static roll angle and pitch angle by comparing the signal from the 6DOF inertial sensor and the vehicle measurement information with a lookup table for pitch angles and a lookup table for roll angles.

That is, the roll/pitch gain calculator 135 assigns more weight to the angle estimates obtained from a gyro integration equation when a vehicle is in a dynamic traveling condition, and assigns more weight to the angle estimates from acceleration sensors when a vehicle is in a static traveling condition. By doing so, the calculation of road slope values becomes more specifically divided.

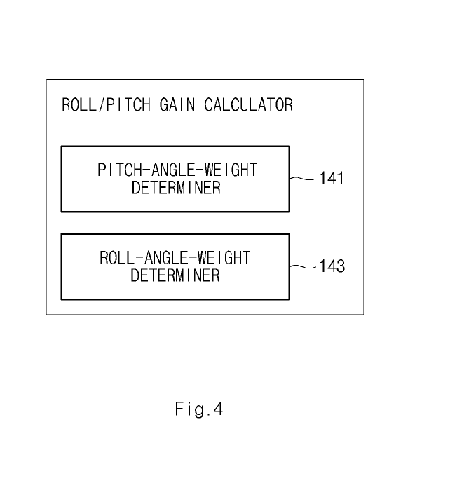

As shown in FIG. 4, the roll/pitch gain calculator 135 may include a pitch-angle-weight determiner 141 and a roll-angle-weight determiner 143.

The pitch-angle-weight determiner 141 may consider the signals of longitudinal acceleration, pitch rate, a lateral slip angle of a rear wheel and yaw rate, and determine a dynamic condition if levels of the signals are increased to reference levels or higher so as to reduce the static pitch angle gain value based on the lookup table for pitch angles.

Here, the pitch-angle-weight determiner 141 may adjust the static pitch angle gain value to a relatively small value, as a value calculated by applying signals of longitudinal acceleration, a pitch rate, a lateral slip angle of a rear wheel and a yaw rate to a predetermined gyro integration equation increases.

Here, the roll-angle-weight determiner 143 takes into consideration of signals of the change rate of the steering angle, lateral acceleration, pseudo vehicle roll and a lateral slip angle of a rear wheel, and, if levels of these signals are above reference levels, determines the vehicle to be in a dynamic condition, such that the roll-angle-weight determiner 143 may adjust the static roll angle gain value to a relatively small value based on the lookup table for roll angles.

Here, the roll-angle-weight determiner 143 may adjust the static roll angle gain value to a relatively small value as a value increases, which is calculated by applying signals of the change rate of the steering angle, lateral velocity, pseudo vehicle roll, and a lateral slip angle of a rear wheel to a predetermined gyro integration equation.

The pseudo vehicle roll means lateral acceleration−longitudinal velocity*yaw rate−time derivative of lateral velocity V_{y}.

The overall vehicle roll/pitch estimator 137 may calculate the overall vehicle roll angle and pitch angle based on the information calculated by the static roll/pitch calculator 131, the initial roll/pitch calculator 133 and the roll/pitch gain calculator 135.

Specifically, the overall vehicle roll/pitch estimator 137 may calculate the overall vehicle roll angle and pitch angle using Equation 6.

$$[ \begin{matrix}{φ}^{\dot{\hat{}}} \\ {θ}^{\dot{\hat{}}} \\ {ψ}^{\dot{\hat{}}}\end{matrix} ] = [ \begin{matrix}1 & sin \hat{φ} tan \hat{θ} & cos \hat{φ} tan \hat{θ} \\ 0 & cos \hat{φ} & - sin \hat{φ} \\ 0 & sin \hat{φ} sec \hat{θ} & cos \hat{φ} sec \hat{θ}\end{matrix} ] [ \begin{matrix}{ω}_{x} \\ {ω}_{y} \\ {ω}_{z}\end{matrix} ] + [ \begin{matrix}{k}_{roll} & 0 \\ 0 & {k}_{pitch} \\ 0 & 0\end{matrix} ] ( [ \begin{matrix}{φ}_{static} \\ {θ}_{static}\end{matrix} ] - [ \begin{matrix}\hat{φ} \\ \hat{θ}\end{matrix} ] ) \qquad [ Equation 6 ]$$

ωₓ, ω_{y} and ω_{z} denote roll rate, pitch rate and yaw rate, respectively, and αₓ, α_{y}, and α_{z} denote longitudinal acceleration, lateral acceleration, and vertical acceleration, respectively.

Further,

$$\vert \begin{matrix}{φ}_{static} \\ {θ}_{static}\end{matrix}$$

denotes static roll angle and pitch angle, kᵣₒₗₗ denotes a roll angle gain value, k_{pitch} denotes a pitch angle gain value, and

$$[ \begin{matrix}\hat{φ} \\ \hat{o} \\ \hat{ψ}\end{matrix} ]$$

denotes a roll angle, a pitch angle and a yaw angle.

In addition, the vehicle suspension angle estimator 150 may calculate a vehicle suspension angle based on the signal from 6DOF inertial sensor and the vehicle measurement information.

Specifically, the vehicle suspension angle estimator 150 may calculate a vehicle suspension angle using Equation 7.

$$[ \begin{matrix}{φ}_{sus\_roll} \\ {θ}_{sus\_pitch}\end{matrix} ] = [ \begin{matrix}\frac{{K}_{sus\_roll}}{{T}_{roll} s + 1} \\ \frac{{K}_{sus\_pitch}}{{T}_{pitch} s + 1}\end{matrix} ] \qquad [ Equation 7 ]$$

Φₛᵤₛ_{_{—}}ᵣₒₗₗ denotes a vehicle suspension roll angle, θₛᵤₛ_{_{—}}_{pitch} denotes a vehicle suspension pitch angle, T denotes a constant, and K_{SUS} denotes a gain value.

The road slope estimator 170 may determine a difference between the overall vehicle angles and a vehicle suspension angle to calculate a road slope. The road slope estimator 170 may calculate a road slope by subtracting the vehicle suspension angle estimated by the vehicle suspension angle estimator 150 from the overall vehicle angles estimated by the vehicle motion estimator 130.

According to the embodiment of the present disclosure, in a situation that a vehicle suspension roll angle and a road lateral slope angle both exist, they may be correctly estimated independently from each other.

In addition, the road slope estimating system 100 may improve a variety of components mounted on a vehicle, and thus the merchantability, and provide better driving experiences. For example, with the road slope estimating system 100, an electronic skid control (ESC) mounted in a vehicle may achieve improvement in sensitivity control deterioration and control on a laterally sloped road, a motor driven power steering (MDPS) may reduce inclination on a laterally sloped road, a lane keeping assist system (LKAS) may improve lane keeping steering experience on a laterally sloped road, and a smart cruise control (SCC) may improve vehicle speed control consistent experience on a longitudinally sloped road.

As stated above, roll/pitch angles of a vehicle and longitudinal/lateral slopes of a road can be estimated in real-time by utilizing the 6DOF inertial sensor as well as a steering wheel sensor and wheel speed sensors.

Further, roll/pitch angles of a vehicle and slope angles of a road are estimated independently from each other in real time, and weight is variably assigned to components in a vehicle according to a driving condition, thereby improving the reliability of the analyzed road slope.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to fall within the scope of the disclosure, and the scope of the disclosure will be defined only by the accompanying claims.

1. A system for estimating a road slope, comprising:
a signal processor receiving raw signal signals including information on acceleration and rotation velocity transmitted from a 6 degrees of freedom (6DOF) inertial sensor, and performing filtering thereon;
a vehicle motion estimator calculating overall angles including weighted gain values of a roll angle and weighted gain values of a pitch angle of a vehicle based on the raw signals from the 6DOF inertial sensor filtered by the signal processor and on vehicle measurement information transmitted from a vehicle sensor different from the 6DOF inertial sensor;
a vehicle suspension angle estimator calculating a vehicle suspension angle based on the signal from the 6DOF inertial sensor and the vehicle measurement information; and
a road slope estimator determining a difference between the overall angles of the vehicle and the vehicle suspension angle so as to calculate the road slope.

2. The system according to claim 1, wherein a plurality of vehicle sensors different from the 6DOF inertial sensor includes a steering angle sensor and wheel speed sensors; and
the vehicle measurement information includes steering angle measurement information and wheel speed measurement information.

3. The system according to claim 1, wherein the signal processor includes:
an offset compensator offset-compensating for the rotation velocity and the acceleration of the vehicle; and
a non-alignment error compensator compensating for an error of the 6DOF inertial sensor itself.

4. The system according to claim 3, wherein the offset compensator performs a rotation velocity correction of the vehicle using Equation 1, and performs an acceleration correction of the vehicle using Equation 2:
$${[ \begin{matrix}{ω}_{x} \\ {ω}_{y} \\ {ω}_{z}\end{matrix} ]}_{offset \text{-} free} = {[ \begin{matrix}{ω}_{x} \\ {ω}_{y} \\ {ω}_{z}\end{matrix} ]}_{raw} - [ \begin{matrix}{ω}_{x , offset} \\ {ω}_{y , offset} \\ {ω}_{z , offset}\end{matrix} ] \qquad [ Equation 1 ]$$
wherein ωₓ, ω_{y}, and ω_{z} denote roll rate, pitch rate and yaw rate, respectively; and
$${[ \begin{matrix}{a}_{x} \\ {a}_{y} \\ {a}_{z}\end{matrix} ]}_{offset \text{-} free} = {[ \begin{matrix}{a}_{x} \\ {a}_{y} \\ {a}_{z}\end{matrix} ]}_{raw} - [ \begin{matrix}{a}_{x , offset} \\ {a}_{y , offset} \\ {a}_{z , offset}\end{matrix} ] \qquad [ Equation 2 ]$$
wherein αₓ, α_{y}, and α_{z} denote longitudinal acceleration, lateral acceleration and vertical acceleration, respectively.

5. The system according to claim 3, wherein the non-alignment error compensator compensates for an orthogonal error at a time of manufacturing the 6DOF inertial sensor, a sensitivity error of the 6DOF inertial sensor itself, and a cross axis sensitivity.

6. The system according to claim 1, wherein the vehicle motion estimator includes:
a static roll/pitch calculator calculating a static roll angle and a static pitch angle of the vehicle using a predetermined acceleration equation;
an initial roll/pitch calculator determining an initial roll angle and an initial pitch angle of the vehicle when the vehicle is static;
a roll/pitch gain calculator calculating weighted gain values of the roll angle and weighted gain values of the pitch angle based on the static roll angle and the static pitch angle reflected in determining an overall angle and a pitch angle; and
an overall vehicle roll/pitch estimator calculating an overall roll angle and a pitch angle of the vehicle based on the information calculated by the static roll/pitch calculator, the initial roll/pitch calculator, and the roll/pitch gain calculator.

7. The system according to claim 6, wherein the roll/pitch gain calculator assigns weight to the static roll angle and the static pitch angle by comparing the signal from the 6DOF inertial sensor and a vehicle measurement information with a lookup table for pitch angles and a lookup table for roll angles.

8. The system according to claim 7, wherein the roll/pitch gain calculator includes:
a pitch-angle-weight determiner determining a dynamic condition if the levels of signals of longitudinal acceleration, a pitch rate, a lateral slip angle of a rear wheel and a yaw rate are equal to or higher than reference levels, and adjusting a static pitch angle gain value to a smaller value based on the lookup table for pitch angles; and
a roll-angle-weight determiner determining the dynamic condition if the levels of signals of a change rate of a steering angle, lateral acceleration, pseudo vehicle roll, and a lateral slip angle of a rear wheel are equal to or higher than reference levels, and adjusting a static roll angle gain value to a smaller value based on the lookup table for roll angles.

9-10. (canceled)
